(19) United States
(12) Patent Application Publication
(10) Pub. No.: US 2026/0048348 A1
(43) Pub. Date: Feb. 19, 2026

(54) CENTRIFUGAL SOLIDS-LIQUID SEPARATOR SYSTEM

(71) Applicant: Christopher Grimh, Flagstaff, AZ (US)

(72) Inventor: Christopher Grimh, Flagstaff, AZ (US)

(21) Appl. No.: 19/369,310

(22) Filed: Oct. 26, 2025

Related U.S. Application Data
(63) Continuation of application No. PCT/US25/41853, filed on Aug. 13, 2025.
(60) Provisional application No. 63/682,582, filed on Aug. 13, 2024.

(51) Int. Cl. B01D 33/56; B01D 33/073; B01D 33/46; B01D 33/74

(52) U.S. Cl. CPC B01D 33/56; B01D 33/073; B01D 33/461; B01D 33/74

(57) ABSTRACT

A centrifugal solids-liquid separator system has a drum that spins about a rotational axis with a helical channel for moving solid particles up into a blower channel and out a blower outlet, wherein the drum is moved with a variable speed to cause the solid particles to move up the helical channel. The helical channel is configured along an inside wall of the drum and the solid particles from a slurry move up along the helical channel to a top flange and over this top flange into the blower channel. The blower then forces the solid particles out of the system. The liquid of the slurry flows from a receiving base configured at the base of the helical channel or drum, out of a liquid outlet to exit the system for collection or disposal. A motor spins the drum and may power the blower to operate the system.

### CROSS REFERENCE TO RELATED APPLICATIONS

This application is a continuation of international patent application PCT/US2025/041853, having an international filing date of Aug. 13, 2025, which claims the benefit of priority to U.S. provisional patent application No. 63/682,582 filed on Aug. 13, 2024; the entirety of which is hereby incorporated by reference herein.

### BACKGROUND OF THE INVENTION

### Field of the Invention

The invention relates to a centrifugal solids-liquid separator system having a drum that spins about a rotational axis with a helical channel for moving solid particles up into a blower channel and out a blower outlet, wherein the drum is moved with a variable speed to cause the solid particles to move up the helical channel.

### Background

Slurry containing liquid and solid particles often requires separation for proper disposal or to reduce the cost of disposal. Also, in some cases the liquid and/or the solid particles can be recycled and therefore require separation. Separation processes often use filtration material that produce waste. Centrifugal separators are often used but with limited efficiency.

### SUMMARY OF THE INVENTION

The invention relates to a centrifugal solids-liquid separator system having a drum that spins about a rotational axis with a helical channel for moving solid particles up into a blower channel and out a blower outlet, wherein the drum is moved with a variable speed to cause the solid particles to move up the helical channel. The drum includes a helical channel configured along an inside wall of the drum that moves the solid particles from a slurry up along the helical channel to a top flange and over this top flange into the blower channel. The blower then forces the solid particles out of the system. The liquid of the slurry flows from a receiving base configured at the base of the helical channel or drum out a liquid outlet to exit the system for collection or disposal.

A motor spins the drum and may power the blower to operate the system. The drum spins about a rotational axis or drive axis and is rotated at a variable speed which causes the solid particles to be moved by inertial up along the helical channel. The speed of the drum may be changed quickly from a first speed to a second speed, accelerated or decelerated, to cause an inertial force that slides the solid particles along the helical channel. The particles move incrementally up along the helical channel to the top and over the top of the drum and into the blower channel. The second rotational speed may be a factor greater than the first rotational speed, such as about 1.5:1 or more, about 2:1 or more, about 4:1 or more, about 5:1 or more, or about 10:1 or more, or any range between and including the ratios provided and vice versa, from the first speed to the second speed; wherein the drum is decelerated. Put another way, the acceleration or deceleration of the drum may be about 1 rpm/sec or more, about 2 rpm/sec or more, about 5 rpm/sec or more, about 10 rpm/sec or more, about 20 rpm/sec or more, and any range between and including the values provided.

The helical channel may include one or more channel offsets to direct fluid down and out of the drum while keeping the solids along the back of the channel. A channel offset is a region where the channel depth quickly reduces to a channel depth that causes the liquid to flow over the channel ridge created by the reduction in channel depth while allowing the particles that are pressed against the back wall of the channel to continue to move up along the helical channel to the outlet. The channel ridge may extend radially along the helical channel to form the channel offset. The channel ridge have a length that is some portion of the channel depth, such as about 25% or more, about 50% or more or even about 75% or more of the channel depth. The drum may include one channel offset, or two or more channel offsets or more, or even four or more channel offsets. A drum may be a split drum, wherein a first portion, such as about half of the drum is offset radially from a second portion, such as a second half of the drum to form these two channel offsets. In a split drum, the two channel offsets may be configured about 180 degrees from each other about the rotational axis or about the inside of the drum.

A blower may blow the solid particles around the blower channer to the blower outlet wherein the solid particles are collected or disposed of. The blower may have a plurality of blades that move within the blower channel to force the solid particles around the blower channel and out the blower outlet. The blades of the blower may be coupled with the drum and spin with the drum, wherein the motor drives both the drum and the blades of the blower. A blower may also be just forced air that is directed along the blower channel. The forced air may force the particles around the blower channel and out the blower exit.

A receiving base may be configured at the base of the interior of the drum and may be coupled to the drum. The slurry may be introduced into the interior of the drum and onto the receiving base. The receiving base may be conical in shape to cause the slurry to flow to the outer perimeter of the receiving base and into the helical channel of the drum. The slurry may be introduced into the drum through an inlet and this inlet may be through the top of the drum. The blower housing may also have a blower housing inlet for the introduction of the slurry into the drum and onto the receiving base. The base may include a filter to let the liquid portion of the slurry to flow therethrough while the solid particles are captured on the surface of the filter. The particles may be moved by gravity and centrifugal force to the outer perimeter of the receiving base and into the helical channel. The particles move up against gravity or vertically up along a rotational axis from the receiving base and into the helical channel. The receiving base may be vertically below the outlet channel, between the top flange of the drum and the blower housing. Also, the receiving base may have a liquid outlet or outlets for channeling the liquid out of the system. One or more liquid outlets may be configured in the receiving base, such as along the outer perimeter adjacent the bottom of the drum or interface of the drum and receiving base. The liquid outlets may be configured proximal to the inside wall.

An outlet channel may be configured between the blower housing and the top of the drum, or the top flange of the drum. The solid particles may pass through the outlet channel from the helical channel and into the blower channel.

The centrifugal solids-liquid separator may include a brush configured radially inward from the helical channels that may be configured in a ring. The brush may be fixed or may be configured to spin or rotate in the same direction as the drum. The brush may extend into the helical channels, and the brush may have bristles or portions that contact the inside wall of the drum or extend into and contact the inside surface of the helical channels. The brush may push or sweep the particles along and up the helical channel when the drum is actuated such as when accelerated or decelerated in rotational velocity. Like the particles, the brush may have a slower acceleration upon a rapid acceleration of the drum and sweep the particles until the brush closely matches the rotational speed of the drum, or may have a slower deceleration and sweep the particles along the helical channels upon a rapid deceleration of the drum. The brush may spin with the drum but may have a delayed response to the changes in velocity of the drum, acceleration or deceleration, and therefore brush particles up the helical channel. Also, the brush may not contact the inside of the drum about the entire inside circumference and may have recessed regions to allow the brush to release from the helical channel such that the brush is not forced up along the helical channel. As described herein, the brush may include bristles that extend radially outward into the helical channel or along the inside wall of the drum.

The slurry may include solid particles and a liquid and the solid particles may be metal, such as metal shaving from a machining process. A slurry may include metal particles, such as aluminum, steel, copper, gold, silver, etc. The solid particles may have a maximum dimension or size across the solid particle, or length or width, of no more than 5 mm, no more than 10 mm, no more than 20 mm and any range between and including the sizes provided. Larger particles, such as but not limited to, greater than 25 mm in maximum dimension may be retained on the receiving base, wherein they are filtered out by the filter configured with the receiving base. Solid particles may be irregular in shape and may have some porosity and the term solid is simply used to differentiate from the liquid component of the slurry. The liquid may include oil or a lubricating liquid for machining.

The invention also is directed to a method of separating solid particles from a liquid. The method utilizes a centrifugal solids-liquid separator as described herein and further includes introducing a slurry containing the solid particles and the liquid into the drum and onto a receiving base. The liquid flows out from the receiving base and the solid particles are moved over the base and into the helical channel along the inside wall of the drum. A motor rotates the drum at a variable speed to cause the solid particles to move up along the helical channel. The drum may also spin the receiving base and the spinning receiving base may force the slurry and liquid and solid particles to the outside of the receiving base due to inertial forces. The drum may be rotated under a controlled manner including rapid acceleration and/or rapid deceleration to cause the solid particles to move due to inertial forces. The solid particles may move when the drum is quickly accelerated thereby required more gradual deceleration, for example, or the drum may be quickly decelerated to cause the solid particles to slide along the helical channel due to momentum and inertial forces, thereby requiring a more gradual acceleration.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective view of a centrifugal solids-liquid separator system having a drum that spins about a rotational axis and having a helical channel for moving solid particles up into a blower channel and out a blower outlet.

FIG. 2 shows a perspective view of an exemplary drum of the centrifugal solids-liquid separator system having blades for the blower extending from an outside wall of the drum.

FIG. 3 shows a side cross sectional view of an exemplary drum of the centrifugal solids-liquid separator system having a helical channel extending along an inside wall and liquid outlets configured in a receiving base of the drum.

FIG. 4 shows a perspective view of an exemplary drum of the centrifugal solids-liquid separator system having a helical channel extending along an inside wall.

FIG. 5 shows a side view of the exemplary drum shown in FIG. 5 having a helical channel extending along an inside wall.

FIG. 6 shows a perspective view of a portion of the drum shown in FIG. 5 having a helical channel extending along an inside wall of said drum.

FIG. 7 shows a drum velocity profile that includes rapid acceleration and deceleration to cause the solid particles to move due to inertial forces.

FIG. 8 shows a perspective view of a centrifugal solids-liquid separator system having a drum that spins about a rotational axis and having a helical channel for moving solid particles up into a blower channel and out a blower outlet.

FIG. 9 shows top view of the centrifugal solids-liquid separator system shown in FIG. 8.

FIG. 10 shows a perspective view of a centrifugal solids-liquid separator system having a drum that spins about a rotational axis and having a helical channel for moving solid particles up into a blower channel and out a blower outlet.

FIG. 11 shows a rotational drum velocity profile that includes rapid acceleration and deceleration to cause the solid particles to move due to inertial forces.

FIG. 12 shows a cut-away view of the centrifugal solids liquid separate system.

FIG. 13 shows a top view of a brush that extends as a ring inside of the drum and has an oval shape with recessed regions from the inside wall of the drum.

FIG. 14 shows a top view of a drum of the centrifugal solids-liquid separator system having a helical channel extending along an inside wall and channel offsets to direct fluid down and out of the drum while keeping the solids along the back of the channel.

FIG. 15 shows side cross-sectional view of the drum shown in FIG. 14 along line 13-13.

FIG. 16 shows a perspective cross-sectional view of the drum shown in FIG. 14 along line 14-14 showing the offset channels to direct fluid out of the drum.

FIG. 17 shows a perspective cross-sectional view of the drum shown in FIG. 14 along line 14-14 with hidden lines to show the contours of the offset channel.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

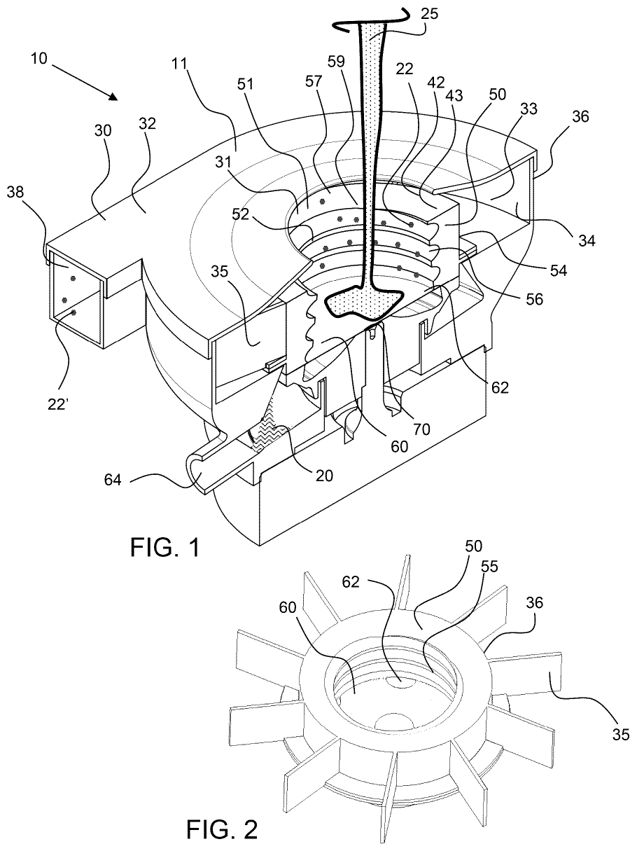

Referring now to FIGS. 1 to 4, an exemplary centrifugal solids-liquid separator system 10 has a drum 50 that spins about a rotational axis 15 and having a helical channel 56 for moving solid particles 22 up through an outlet channel 43 into a blower channel 33 and out a blower outlet 38. As shown in FIG. 1, a slurry 25 is introduced into the interior 51 of the drum 50 through an inlet 55, an opening in the top of the drum. The liquid 20 of the slurry 25 is filtered through a filter 70 and out a liquid outlet 62 in the receiving base 60 of the drum 50. The solid particles 22 move to the inside wall 52 of the drum 50 and are picked up by the helical channel 56 spiraling along the inside wall to a top flange 59 of the drum, the helical channel outlet 57 wherein the solid particles move from the helical channel to the blower channel. The solid particles move through the outlet channel 43, between the top flange 59 and the blower housing 32 and are forced through the blower channel 33 by the blades 35 and out the blower outlet 38. The expelled solid particles 22′ from the blower outlet 38 may be collected for disposal or recycling. The centrifugal solids-liquid separator 11 has a slurry opening 42 such as a blower housing inlet 31. The blower channel is concentric with the wall of the drum, extending around the outside wall of the drum. The outside wall 54 of the drum may form a wall of the blower channel. The outside surface 36 or outside wall may extend in a circle around the drum 50.

As shown in FIG. 2, an exemplary drum 50 of the centrifugal solids-liquid separator system has blades 35 for the blower extending from an outside wall 54 of the drum. The blades are integral to the drum and spin within the blower channel 33, shown in FIG. 1. Also shown in FIG. 2 is a liquid outlet 62 in the receiving base 60 of the drum 50.

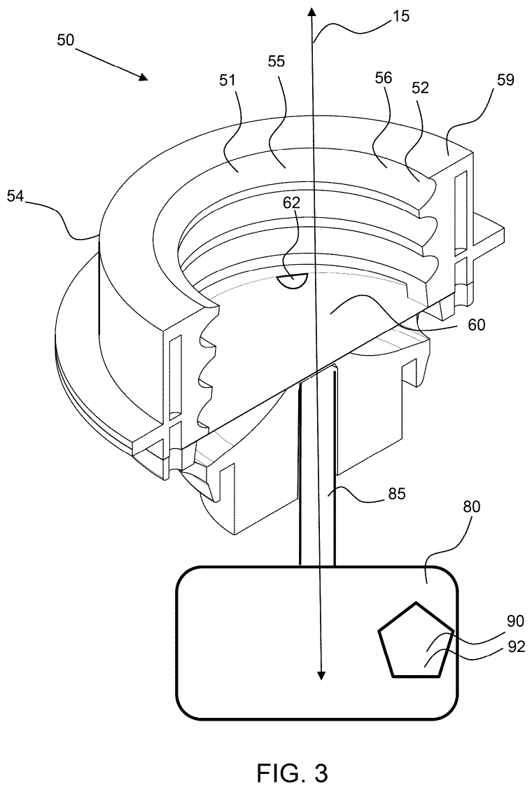

As shown in FIG. 3, an exemplary drum 50 of the centrifugal solids-liquid separator system has a helical channel 56 extending along an inside wall 52 and liquid outlets 62 configured in a receiving base 60 of the drum. The receiving base 60 is conical in shape sloping down from an elevated center portion to the inside wall 52 of the drum 50. This conical shape or sloping surface of the receiving base down to the inside wall promotes the liquid to flow through the liquid outlets 62 in the receiving base 60. The helical channel 56 spirals along the inside wall 52 to the top flange 59 of the drum 50.

As shown in FIG. 3, a motor 80 may be coupled to the drum 50, such as by a drive shaft 85 to spin or rotate the drum. A controller 90 may operate a software program 92 to control the velocity profile of the drum.

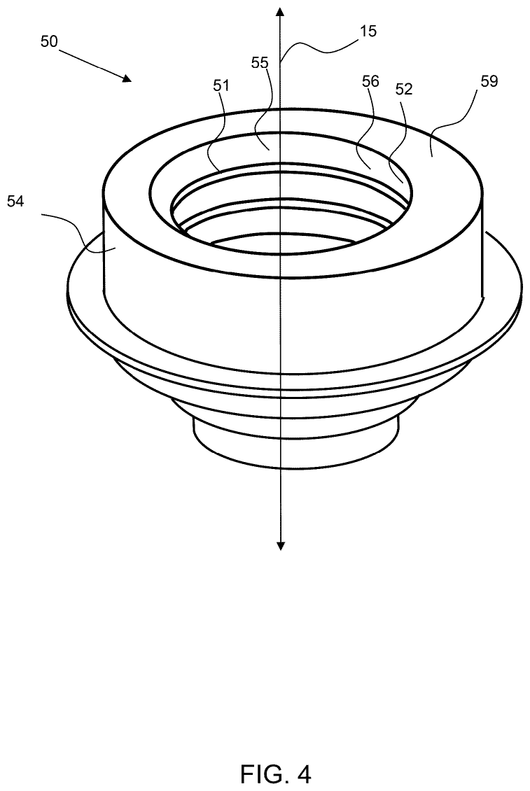

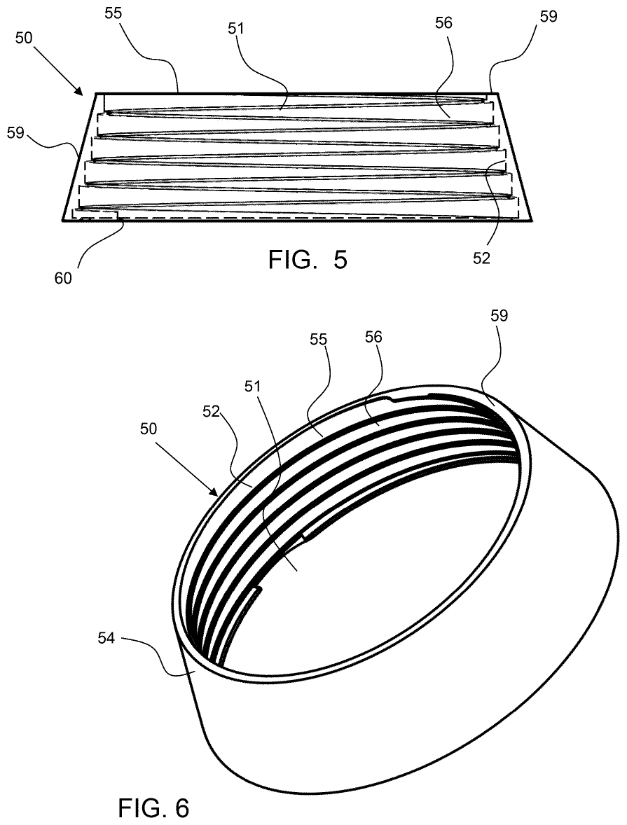

Referring now to FIGS. 4 to 6, an exemplary drum 50 of the centrifugal solids-liquid separator system has a helical channel 56 extending along an inside wall 52. As shown in FIGS. 5 and 6, the inside surface of the drum tapers from the receiving base 60 to the top flange 59, wherein the diameter of the inside wall at the top flange 59 is smaller than the diameter across the interior 51 of the drum at the receiving base 60.

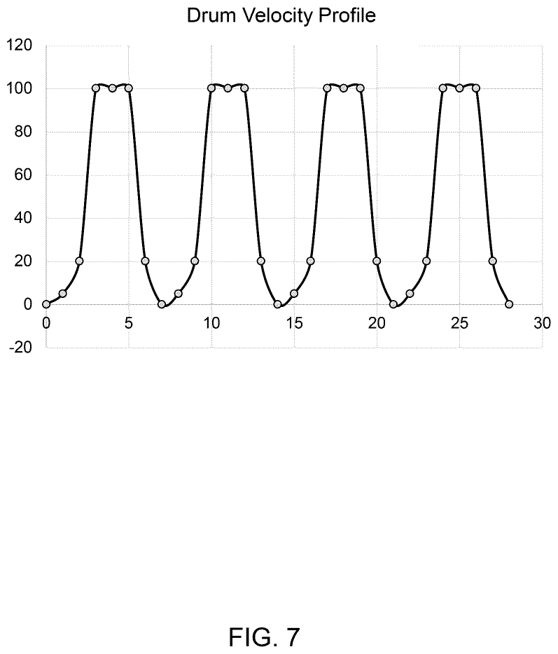

As shown in FIG. 7, a drum velocity profile, the rotational speed profile, includes rapid acceleration and rapid deceleration to cause the solid particles to move due to inertial forces.

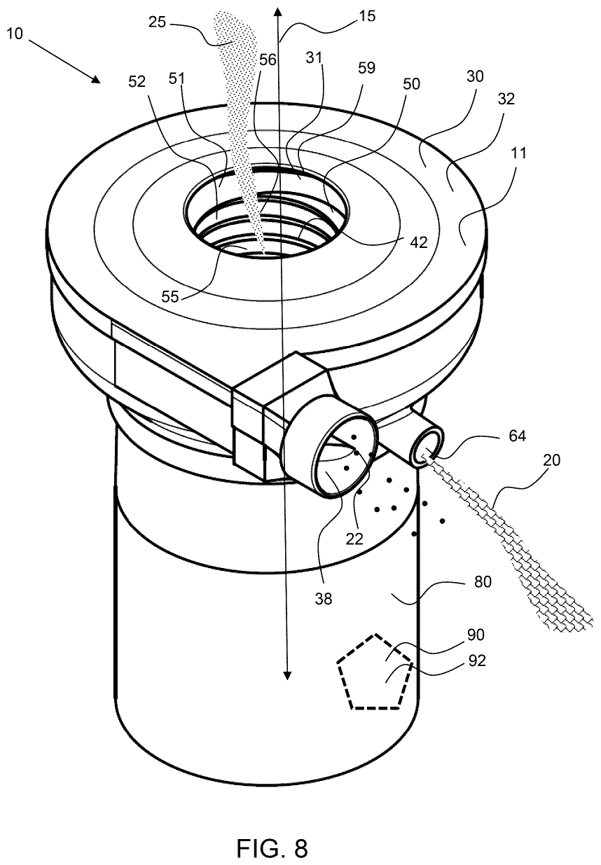

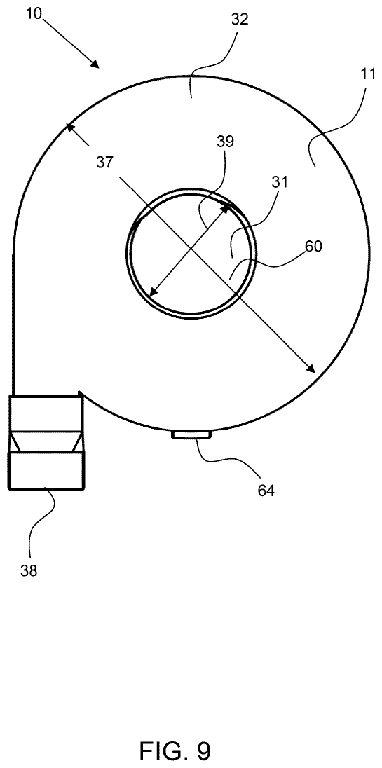

Referring now to FIGS. 8 to 10, a centrifugal solids-liquid separator system 10 has a drum 50 that spins about a rotational axis 15 and has a helical channel 56 for moving solid particles up into a blower channel 33 of a blower 30 and out the blower outlet 38. A motor 80 drives the drum and the blower blades 35. The drum has a helical channel 56 extending along an inside wall 52 of the interior 51 of the drum 50. The blower housing 32 has a blower housing inlet 31 to receive the slurry therein. The centrifugal solids-liquid separator 11 has a slurry opening 42 such as a blower housing inlet 31. The blower housing 32 has a diameter 37 and the slurry opening 42 of the housing 40, or blower housing inlet 31 has a diameter 39 as shown in FIG. 9. The slurry opening may be centrally located as shown or offset from a centerline of the drum and is within the outer perimeter of the housing 40 or blower housing 32 as shown.

The drum has an inlet 55 at the top to receive slurry therein. The solid particles of the slurry move up along the helical channel 56 to the top flange 59 and then over the top flange and into the blower channel 34. The blower blades push the particles out of the blower outlet 38. The liquid 20 of the slurry flows liquid outlets 62 in the receiver base 60 and then flows out the liquid outlet pipe 64.

As shown in FIG. 8, a centrifugal solids-liquid separator system 10 has a drum 50 that spins about a rotational axis 15 and has a helical channel 56 for moving solid particles 22 up into a blower channel of a blower 30 and out the blower outlet 38. A motor 80 is configured to rotate the drum 50 and drives the blower 30 about the rotational axis 15 or drive axis. A slurry opening 42 in the housing 40 of the centrifugal solids-liquid separator 11, which includes the blower housing 32, forms a housing inlet 31 and directs slurry into the drum 50 and onto the receiving base. The drum has an inlet at the top to receive slurry therein. The solid particles of the slurry move up along the helical channel 56 to the top flange 59 and then over the top flange and into the blower channel 34 that extends around the outside of the drum and forms a ring around the drum as shown. The blower blades push the particles out of the blower outlet 38. The liquid 20 of the slurry flows through liquid outlets in the receiver base and then flows out the liquid outlet pipe 64.

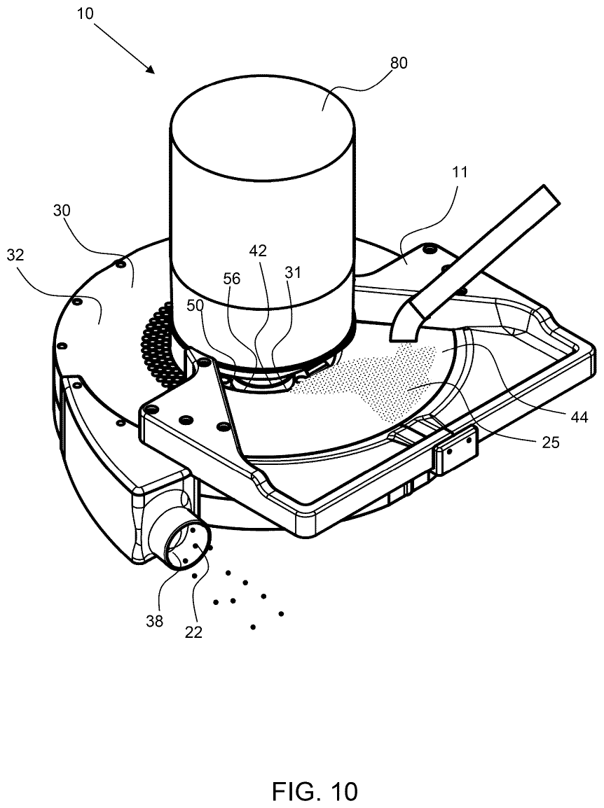

As shown in FIG. 10, a slurry flange 44 directs slurry 25 into the slurry opening 42.

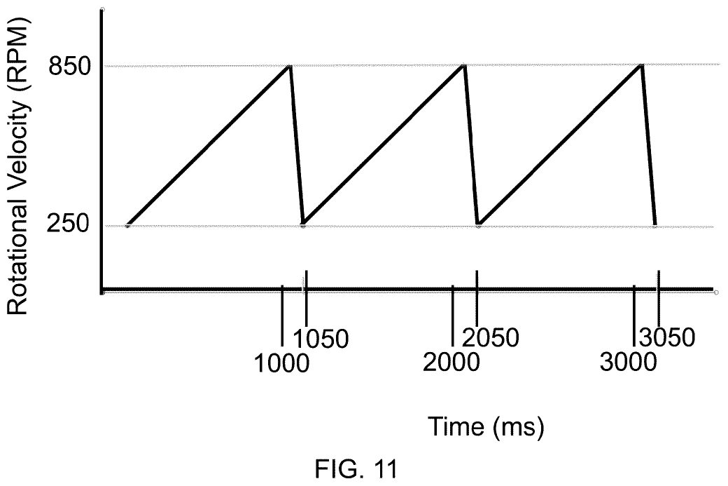

As shown in FIG. 11, a rotational drum velocity profile includes acceleration of the drum and then much more rapid deceleration of the drum to cause the solid particles to move due to inertial forces. The slope of the line is the rate of acceleration and deceleration.

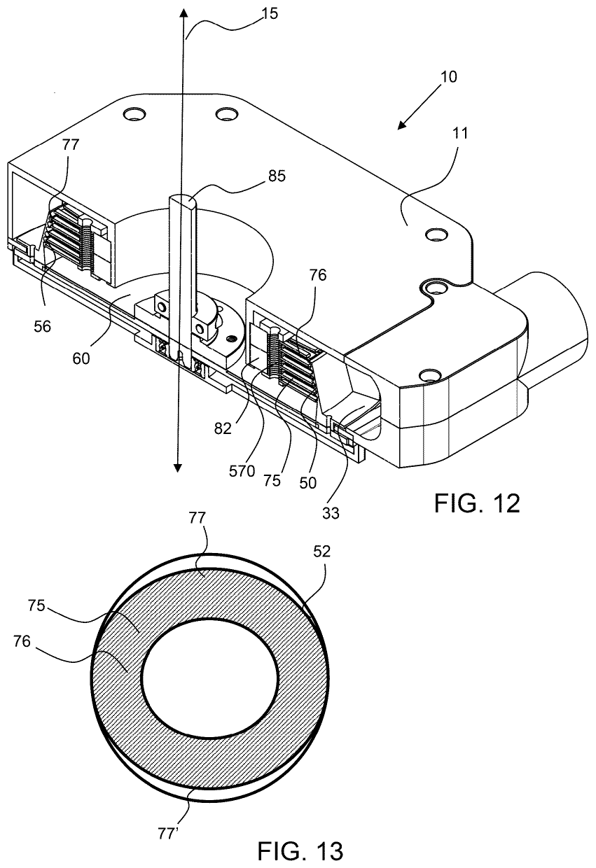

Referring to FIGS. 12 and 13, the centrifugal solids liquid separate system 10 has a drum with helical channels 56 to move particles up along the tapering helical channels to an outlet, where the particles are ejected from the system. The drive shaft 85 drives the helical drum and bearings 82 may be configured radially inward from the helical channels 56 of the drum 50. Also, a drum filter 570 is configured between the receiving base 60 and the helical channels 56. A brush 75 may be configured radially inward from the helical channels and may be configured in a ring that may move with the rotation of the drum. The brush may extend into the helical channels and the brush may have bristles 76 or portions that contact the inside wall 52 of the drum 50 or extend into and contact the inside surface of the helical channels 56. The bristles may extend radially from the rotational axis 15 and extend into the helical channels. The brush may push or sweep the particles along and up the helical channel when the drum is accelerated in rotational velocity. The brush may rotate or spin with the drum but may have a delayed response to the change in velocity of the drum and therefore brush particles up the helical channel. Also, as shown in FIG. 13, the brush may not contact the inside of the drum about the entire inside circumference and may have recessed regions 77, 77′ to allow the brush to release from the helical channel such that the brush is not forced up along the helical channel. As shown, the brush extends in a ring and has an oval shape. As described herein, the brush may include bristles that extend radially outward into the helical channel or along the inside wall of the drum.

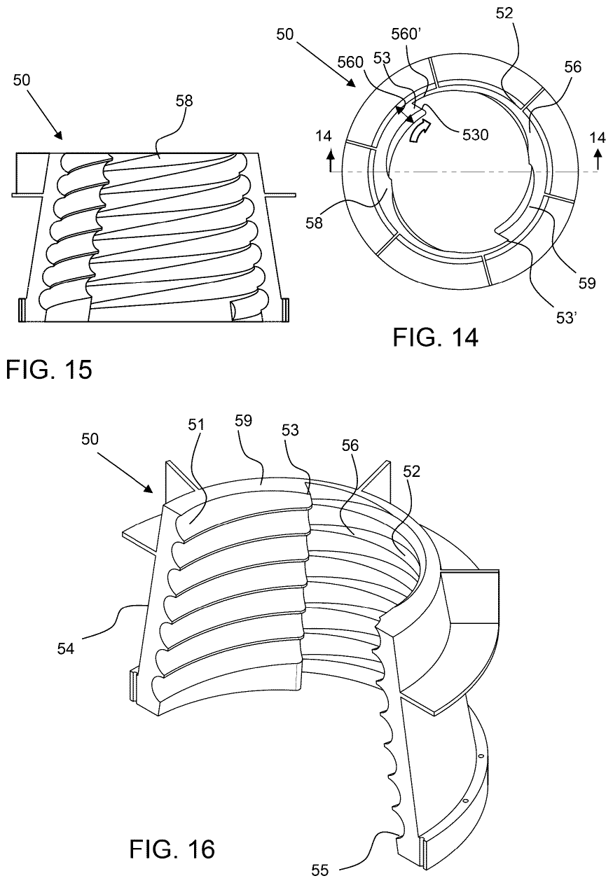

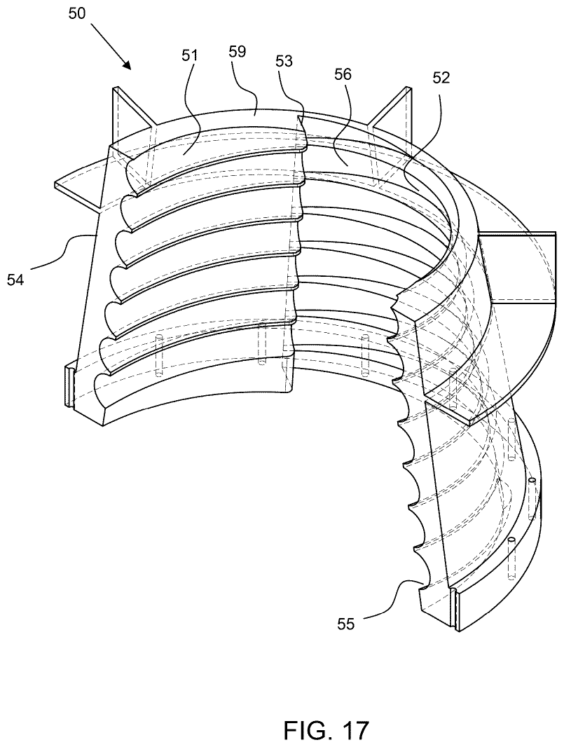

Referring now to FIGS. 14 to 17, a drum 50 has a helical channel 56 extending along an inside wall 52 and channel offsets 53 to direct fluid down and out of the drum while keeping the solids along the back of the channel. A channel offset 53 is a region where the channel depth 560 quickly reduces to a channel depth 560′ that causes the liquid to flow over the channel ridge 530 created by the reduction in channel depth while allowing the particles that are pressed against the back wall of the channel to continue to move up along the helical channel 56 to the outlet. As shown in FIG. 14, the helical channel 56 has two channel offsets 53, 53′ formed by a split drum 58, wherein a first portion, such as about half of the drum is offset radially from a second portion, such as a second half of the drum to form these two channel offsets. In a split drum, the two channel offsets 53, 53′ may be configured about 180 degrees from each other about the rotational axis or about the inside 52 of the drum. FIG. 17 shows broken lines to better depict the curvature of the helical channel along the channel offset 53.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A centrifugal solids-liquid separator system utilizing a centrifugal solids-liquid separator to separate solid particles from a liquid of a slurry, said centrifugal solids-liquid separator system comprising:
a) a blower housing configured around a blower having blades to force air through a blower channel;
b) a drum configured radially inward from the blades; said drum comprising:
i) an interior with an inside wall and a receiving base;
ii) a liquid outlet in said base to allow a liquid of said slurry to flow out of said drum;
iii) a filter over said base having filter openings that allow said liquid to pass therethrough but prevents solid particles from passing therethrough; and
iv) a helical channel extending along an inside wall of the drum;
v) an outlet channel configured between the helical channel and the blower channel; and
c) a motor that spins the drum at variable speeds to produce an inertial force on said solid particles to move the solid particles up along the helical channel;
wherein the centrifugal solids-liquid separator system is configured to move the solid particles incrementally along the helical channel through said outlet channel and into the blower channel, wherein the particles are forced through the blower channel to an outlet.

2. The centrifugal solids-liquid separator system of claim 1, wherein the blades of the blower are coupled with the drum and spin with the drum.

3. The centrifugal solids-liquid separator system of claim 1, wherein the receiving base is conical in shape to cause liquid to flow radially outward to said liquid outlet.

4. The centrifugal solids-liquid separator system of claim 3, wherein the drum has a plurality of liquid outlets.

5. The centrifugal solids-liquid separator system of claim 4, wherein liquid outlets are configured proximal to the inside wall.

6. The centrifugal solids-liquid separator system of claim 1, wherein the outlet channel is configured between a top flange of the drum and the blower channel.

7. The centrifugal solids-liquid separator system of claim 1, wherein the centrifugal solids-liquid separator has a slurry opening for receiving the slurry of the solid particles and the liquid.

8. The centrifugal solids-liquid separator system of claim 1, wherein the motor changes the rotational speed of the drum to create inertial forces to move the solid particles up along the helical channel to the blower channel.

9. The centrifugal solids-liquid separator system of claim 8, wherein the motor spins the drum at a first speed and then stops the drum to create inertial forces to move the solid particles up along the helical channel to the blower channel.

10. The centrifugal solids-liquid separator system of claim 1, wherein the slurry of the liquid and solid particles is a machining slurry comprising a machining liquid and machined particles.

11. The centrifugal solids-liquid separator system of claim 1, wherein the blower channel is configured between an outside wall of the drum and the blower housing.

12. The centrifugal solids-liquid separator system of claim 1, wherein the inside wall of the drum tapers from the receiving base to a top flange of the drum.

13. The centrifugal solids-liquid separator system of claim 1, wherein the centrifugal solids-liquid separator further comprises a brush configured along the inside surface of the drum.

14. The centrifugal solids-liquid separator system of claim 13, wherein the brush contacts the helical channel and forces the particles along the helical channel.

15. The centrifugal solids-liquid separator system of claim 14, wherein the brush is configured to rotate when the drum rotates.

16. The centrifugal solids-liquid separator system of claim 15, wherein the brush is ring shaped.

17. The centrifugal solids-liquid separator system of claim 14, wherein the brush is ring shaped.

18. The centrifugal solids-liquid separator system of claim 17, wherein the brush rotates when the drum rotates.

19. The centrifugal solids-liquid separator system of claim 17, wherein the brush has an oval outer perimeter shape.

20. The centrifugal solids-liquid separator system of claim 19, wherein the brush has recessed regions that do not contact the helical channel.

21. The centrifugal solids-liquid separator system of claim 14, wherein the brush has recessed regions that do not contact the helical channel.

22. The centrifugal solids-liquid separator system of claim 14, wherein the helical channel comprises a channel offset, wherein a channel depth of the helical channel is reduced to produce a channel ridge configured to allow the liquid to flow over the channel ridge.

23. The centrifugal solids-liquid separator system of claim 22, wherein the helical channel comprise two channel offsets.

24. The centrifugal solids-liquid separator system of claim 23, wherein the drum is a split drum.

25. The centrifugal solids-liquid separator system of claim 1, wherein the helical channel comprises a channel offset, wherein a channel depth of the helical channel is reduced to produce a channel ridge configured to allow the liquid to flow over the channel ridge.

26. The centrifugal solids-liquid separator system of claim 25, wherein the helical channel comprises two channel offsets.

27. The centrifugal solids-liquid separator system of claim 26, wherein the drum is a split drum.

28. A method of separating solid particles from liquid comprising:
a) providing a centrifugal solids-liquid separator system of claim 1;
b) introducing the slurry comprising the solid particles and the liquid into the drum;
c) filtering the liquid through the filter, wherein the solid particles move to the helical channel;
d) spinning the drum at a variable speed to incrementally move the particles up along the helical channel to the outlet channel and into the blower channel; and
e) blowing the particles through the blower and out an outlet of the blower.
